(19) United States
(12) Patent Application Publication
(10) Pub. No.: US 2025/0192860 A1
(43) Pub. Date: Jun. 12, 2025

(54) Explicit Common Beam Index Configuration for Physical Uplink Control Channel (PUCCH)

(71) Applicant: Telefonaktiebolaget LM Ericsson (publ), Stockholm (SE)

(72) Inventors: Andreas Nilsson, Göteborg (SE); Shiwei Gao, Nepean (CA); Siva Muruganathan, Stittsville (CA)

(21) Appl. No.: 18/842,450

(22) PCT Filed: Mar. 3, 2023
(86) PCT No.: PCT/EP2023/055453

§ 371 Date: Aug. 29, 2024

Related U.S. Application Data
(60) Provisional application No. 63/316,615, filed on Mar. 4, 2022.

(51) Int. Cl. H04B 7/06; H04L 5/00; H04W 72/21

(52) U.S. Cl. CPC H04B 7/06952; H04L 5/0091; H04W 72/21

(57) ABSTRACT

A method, system and apparatus for explicit common beam index configurations for a physical uplink control channel (PUCCH) are disclosed. According to one aspect, a method in a wireless device (WD) includes receiving a common beam index configuration, the common beam index configuration indicating at least one common beam index, each of the at least one common beam index being associated with a unified transmission configuration indication (TCI), state of a plurality of unified TCI states. The method also includes determining a first spatial filter for a first physical uplink control channel, PUCCH, transmission based at least in part on a first unified TCI state associated with a first common beam index of the at least one common beam index.

### TECHNICAL FIELD

The present disclosure relates to wireless communications, and in particular, to explicit common beam index configurations for a physical uplink control channel (PUCCH).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

NR uses CP-OFDM (Cyclic Prefix Orthogonal Frequency Division Multiplexing) in both downlink (i.e., from a network node, gNB, or base station, to a user equipment (UE) or wireless device (WD)) and uplink (i.e., from WD to gNB). Discrete Fourier transform (DFT)-spread OFDM is also supported in the uplink. In the time domain, NR downlink and uplink are organized into equally-sized subframes of 1 ms each. A subframe is further divided into multiple slots of equal duration. The slot length depends on subcarrier spacing. For subcarrier spacing of Δƒ=15 kHz, there is only one slot per subframe and each slot has 14 OFDM symbols.

Data scheduling in NR is typically on a per-slot basis. An example is shown in FIG. 1 with a 14-symbol slot, where the first two symbols contain the physical downlink control channel (PDCCH) and the remaining symbols contain the physical shared data channel (PSDCH) or the physical uplink shared channel (PUSCH).

Different subcarrier spacing values are supported in NR. The supported subcarrier spacing values (also referred to as different numerologies) are given by Δƒ=(15×2^{μ})kHz where μ∈0,1,2,3,4. Δƒ=15 kHz is the basic subcarrier spacing. The slot duration at different subcarrier spacings is given by

$$\frac{1}{{2}^{μ}} ms .$$

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink and uplink transmissions can be either dynamically scheduled in which the network node (e.g., gNB) transmits a DL assignment or a uplink grant via downlink control information (DCI) over PDCCH (Physical Downlink Control Channel) to a WD for each PDSCH or PUSCH transmission, or semi-persistent scheduled (SPS) in which one or more DL SPS or UL configured grants (CGs) are semi-statically configured and each can be activated or deactivated by a DCI.

### TCI States and QCL

A Transmission Configuration Indication (TCI) state contains Quasi Co-location (QCL) information between two antenna ports. Two antenna ports are said to be QCL if certain channel parameters associated with one of the two antenna ports can be inferred from the other antenna port. An antenna port in NR is defined by a reference signal.

The supported QCL information types in NR include:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay}; and
‘QCL-TypeD’: {Spatial Rx parameter}.

A TCI state contains one or two DL reference signals such as a CSI-RS (Channel State Information Reference Signal) and/or a SSB (Synchronization Signal Block). When a TCI state is indicated for a physical downlink shared channel (PDSCH) or physical downlink control channel (PDCCH), it means that the Demodulation Reference signal (DMRS) of the PDSCH or PDCCH is quasi co-located with the reference signals contained in the TCI state with respect to certain channel properties such as average delay and delay spread.

A TCI state information element is shown below, where two QCL types are indicated, one of them being a type-D QCL.

TCI-State information element

| -- ASN1START | |
|---|---|
| -- TAG-TCI-STATE-START | |
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, |

```
typeD},
    ...
  }
  -- TAG-TCI-STATE-STOP
  -- ASN1STOP
```

For the PDCCH, a list of TCI states can be configured by radio resource control (RRC) signaling for a control resource set (CORESET) and one of the TCI states is activated by a MAC CE. For example, if a SSB is configured as the QCL-typeD source RS in an activated TCI state for a CORESET, the same receive beam for receiving the SSB can be used by a WD to receive PDCCHs transmitted in the CORESET.

For the PDSCH, a list of TCI states can be RRC configured in a higher layer parameter PDSCH-Config information element (IE), Up to 8 TCI states from the list can be activated with a medium access control (MAC) control element (CE). In NR 3GPP Technical Release 15 (3GPP Rel-15), one TCI state is activated by a MAC CE for each TCI codepoint of a TCI field in downlink control information (DCI), where up to 8 TCI codepoints can be supported. In NR 3GPP Rel-16, up to two TCI states can be activated by a MAC CE for each TCI codepoint. For dynamically scheduled PDSCH, one of the TCI codepoints is indicated in the TCI field of the DCI (DCI format 1_1 or DCI format 1_2) scheduling the PDSCH for PDSCH reception. For example, if an SSB or CSI-RS is configured as the QCL-typeD source reference signal (RS) in an activated TCI state indicated to a PDSCH, the same receive beam for receiving the SSB or CSI-RS would be used by a WD to receive the PDSCH.

### Physical Uplink Control Channel (PUCCH)

In NR, the PUCCH is used to carry uplink control information (UCI) such as hybrid automatic repeat request acknowledgement (HARQ-ACK), channel state information (CSI), or scheduling requests (SR).

There are five PUCCH formats defined in NR, i.e., PUCCH formats 0 to 4, with different payload capacities and durations in time. A WD can be configured with multiple PUCCH resources, each associated with a PUCCH format.

Spatial relation is used in NR to refer to a spatial relationship between an UL channel or signal, such as PUCCH, PUSCH and sounding reference signal (SRS), and a DL RS, such as a channel state information reference signal (CSI-)RS, SSB, or an UL SRS. If an UL channel is spatially related to a DL RS, a WD is expected to transmit the UL channel with a same antenna pattern or beam as that used for receiving the DL RS. If a UL channel is spatially related to a UL SRS, then the WD is expected to apply a same antenna pattern or beam as that for the UL channel and the SRS. Up to 64 PUCCH spatial relations can be configured for a WD. For each PUCCH resource, one of the spatial relations can be activated or updated by a command carried in a Medium Access Control (MAC) Control Element (CE).

A PUCCH spatial relation IE by which a WD can be configured for an UL bandwidth part (BWP) in NR is set forth below. It includes one of an SSB index, a CSI-RS resource index, and SRS resource index as well as some power control parameters such as a pathloss reference RS Index, a P0-PUCCH index, and a closed-loop index.

PUCCH-SpatialRelationInfo information element

```
  -- ASN1START
  -- TAG-PUCCH-SPATIALRELATIONINFO-START
```

| PUCCH-SpatialRelationInfo ::= | SEQUENCE { | |
|---|---|---|
| pucch-SpatialRelationInfoId | PUCCH-SpatialRelationInfoId, | |
| servingCellId | ServCellIndex | OPTIONAL, -- |

Need S

| | |
|---|---|
| referenceSignal | CHOICE { |
| ssb-Index | SSB-Index, |
| csi-RS-Index | NZP-CSI-RS-ResourceId, |
| srs | PUCCH-SRS |

},

| | |
|---|---|
| pucch-PathlossReferenceRS-Id | PUCCH-PathlossReferenceRS- |

Id,

| | |
|---|---|
| p0-PUCCH-Id | P0-PUCCH-Id, |
| closedLoopIndex | ENUMERATED { i0, i1 } |

}

| | |
|---|---|
| PUCCH-SpatialRelationInfoExt-r16 ::= | SEQUENCE { |
| pucch-SpatialRelationInfoId-v1610 | PUCCH- |
| SpatialRelationInfoId-v1610 | OPTIONAL, -- Cond |

SetupOnly

| | |
|---|---|
| pucch-PathlossReferenceRS-Id-v1610 | PUCCH- |
| PathlossReferenceRS-Id-v1610 | OPTIONAL, -- Need R |

```
    ...
  }
```

| | |
|---|---|
| PUCCH-SRS ::= | SEQUENCE { |
| resource | SRS-ResourceId, |
| uplinkBWP | BWP-Id |

```
  }
  -- TAG-PUCCH-SPATIALRELATIONINFO-STOP
  -- ASN1STOP
```

### Multi-TRP PUCCH

In NR 3GPP Rel-17, it has been proposed to introduce UL enhancement with multiple TRPs (transmission and reception Points) by transmitting a PUCCH towards different TRPs in different times, or PUCCH repetition to multiple TRPs. An example is shown in FIG. 3 where a PUCCH is repeated twice in time, once to each of two TRPs.

To support PUCCH repetition towards two TRPs, a PUCCH resource may be activated with up to two spatial relations, each associated with one of two TRPs.

### Beam Management With Unified TCI Framework

TCI state and spatial relation based DL and UL beam management framework allows flexibility for the network node to instruct the WD to receive signals from different spatial directions in DL and transmit signals to different spatial directions in UL with a cost of large signaling overhead and slow beam switch. These limitations are particularly noticeable and costly when WD movement is considered because beam update using DCI can only be performed for PDSCH. Then, MAC-CE and/or RRC is required to update the beam for other reference signals/channels, which causes extra overhead and latency.

Furthermore, in a majority of cases, the network transmits to and receives from a WD in the same direction for both data and control. Hence, using a separate framework (i.e., TCI states in DL and spatial relations in UL) for different channels/signals complicates the implementations.

In 3GPP Rel-17, a common beam framework was introduced to simplify beam management in FR2, in which a common beam represent by a unified TCI state may be activated/indicated to a WD and the common beam is applicable for multiple channels/signals. The common beam framework is also referred to as a unified TCI state framework.

The new framework can be RRC configured in one of two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels.

A unified TCI state can be updated in a similar way as the TCI state update for PDSCH in 3GPP Rel-15/16, i.e., with one of two alternatives:
Two-stage: RRC signaling is used to configure a number of unified TCI states in higher layer parameter PDSCH-config, and a MAC-CE is used to activate one of unified TCI states; and
Three-stage: RRC signaling is used to configure a number of unified TCI states in PDSCH-config, a MAC-CE is used to activate up to 8 unified TCI states, and a 3-bit TCI state bitfield in DCI is used to indicate one of the activate unified TCI states.

One activated or indicated unified TCI state will be used in subsequent PDCCH and PDSCH transmissions until a new unified TCI state is activated or indicated.

The existing DCI formats 1_1 and 1_2 are reused for beam indication, both with and without DL assignment. For DCI formats 1_1 and 1_2 with DL assignment, ACK/NACK of the PDSCH can be used as indication of successful reception of beam indication. For DCI formats 1_1 and 1_2 without DL assignment, a new ACK/NACK mechanism analogous to that for SPS PDSCH release with both type-1 and type-2 HARQ-ACK codebook is used, where upon a successful reception of the beam indication DCI, the WD reports an ACK.

For DCI-based beam indication, the first slot to apply the indicated TCI is at least Y symbols after the last symbol of the acknowledgment of the joint or separate DL/UL beam indication. The Y symbols are configured by the network node (gNB) based on WD capability, which is also reported in units of symbols.

In the unified TCI state framework introduced in 3GPP Rel-17, only a single common beam or unified TCI state can be activated or indicated at each time. Thus, it is only applicable to data transmissions from or to a single TRP. Although PUCCH transmissions towards multiple TRPs (or mTRP) are supported in 3GPP Rel-17, these PUCCH transmissions rely on the legacy spatial relations framework. In case a WD is served by two TRPs and activated with two unified TCI states, (either “Joint DL/UL TCI” or “Separate DL/UL TCI”), how to associate a PUCCH transmission to one or both of the two unified TCI states is an open problem.

### SUMMARY

It may be an object of the present disclosure to provide methods and devices that may enable an association between an uplink control data transmission and one or more TCI states in a simple manner.

Some embodiments advantageously provide methods, systems, and apparatuses, e.g. network nodes and WDs, that provide explicit common beam index configurations for a physical uplink control channel (PUCCH).

Multiple solutions are provided to determine a spatial filter for PUCCH transmissions for mTRP operation for the unified TCI state framework using explicitly configured common beam indices.

In some embodiments, association of a PUCCH transmission to one or more common beams for multi-TRP based transmission under a unified TCI state framework is provided.

According to one aspect, a WD configured to communicate with a network node is provided. The WD includes a radio interface configured to receive a common beam index configuration. The common beam index configuration indicates at least one common beam index, and each of the at least one common beam index is associated with a unified transmission configuration indication, TCI, state of a plurality of unified TCI states. The WD also includes processing circuitry in communication with the radio interface and configured to determine a first spatial filter for a first physical uplink control channel, PUCCH, transmission based at least in part on a first unified TCI state associated with a first common beam index of the at least one common beam index.

According to this aspect, in some embodiments, the common beam index configuration includes three different logical values. A first logical value indicates an association to the first unified TCI state of the plurality of unified TCI states, a second logical value indicates an association to a second unified TCI state of the plurality of unified TCI states, and a third logical value indicates an association to both a first and a second unified TCI state of the plurality of unified TCI states. In some embodiments, the processing circuitry is configured to determine a second spatial filter for a second PUCCH transmission based at least in part on a second unified TCI state associated with the second common beam index of the at least one common beam index. In some embodiments, the processing circuitry is configured to determine a first spatial filter for a first PUCCH transmission based at least in part on a first unified TCI state associated with a configured first common beam index of the at least one common beam index and to determine a second spatial filter for a second PUCCH transmission based at least in part on a second unified TCI state associated with a configured second common beam index of the at least one common beam index. In some embodiments, the processing circuitry is configured to determine a first and a second spatial filter for a first PUCCH transmission based at least in part on a first and a second unified TCI state associated with a configured first and second common beam index of the at least one common beam index. In some embodiments, the common beam index configuration indicates an association of the first PUCCH transmission with a first common beam index when a first bit of the common beam index configuration is a first logical value and indicates an association of the first PUCCH transmission with a second common beam index when the first bit of the common beam index configuration is a second logical value. In some embodiments, the common beam index configuration indicates an association of the first PUCCH transmission with a first common beam index and indicates an association with a second PUCCH transmission with a second common beam index when the first bit of the common beam index configuration is a third logical value. In some embodiments, the common beam index configuration indicates an association of the first PUCCH transmission with a first common beam index and with a second common beam index when the first bit of the common beam index configuration is a third logical value. In some embodiments, the radio interface is configured to receive the common beam index configuration by radio resource control, RRC, signaling. In some embodiments, each unified TCI state of the plurality of unified TCI states is one of a joint UL/DL TCI state and a separate UL/DL TCI state. In some embodiments, the processing circuitry is configured by a medium access control, MAC, control element, CE, to activate a plurality of the unified TCI states for each of at least one codepoint in a TCI field of a downlink control information, DCI, message. In some embodiments, the radio interface is configured to receive an indication of a TCI codepoint and the processing circuitry is configured to activate a plurality of unified TCI states associated with the indicated TCI codepoint. In some embodiments, the processing circuitry is configured to assume a TCI state of the activated unified TCI states for at least one of a downlink, DL, signal and an uplink, UL, signal. In some embodiments, the processing circuitry is configured to associate one of a PUCCH resource and a PUCCH resource group with one of a plurality of common beam indices configured by the common beam index configuration. In some embodiments, the processing circuitry is configured to associate one of a PUCCH resource and a PUCCH resource group with two of a plurality of common beam indices configured by the common beam index configuration.

According to another aspect, a method in a wireless device, WD, configured to communicate with a network node is provided. The method includes receiving a common beam index configuration. The common beam index configuration indicates at least one common beam index, and each of the at least one common beam index is associated with a unified transmission configuration indication, TCI, state of a plurality of unified TCI states. The method also includes determining a first spatial filter for a first physical uplink control channel, PUCCH, transmission based at least in part on a first unified TCI state associated with a first common beam index of the at least one common beam index.

According to this aspect, in some embodiments, the common beam index configuration includes three different logical values. A first logical value indicates an association to the first unified TCI state of the plurality of unified TCI states, a second logical value indicates an association to a second unified TCI state of the plurality of unified TCI states, and a third logical value indicates an association to both a first and a second unified TCI state of the plurality of unified TCI states. In some embodiments, the method includes determining a second spatial filter for a second PUCCH transmission based at least in part on a second unified TCI state associated with the second common beam index of the at least one common beam index. In some embodiments, the method includes determining a first spatial filter for a first PUCCH transmission based at least in part on a first unified TCI state associated with a configured first common beam index of the at least one common beam index and determining a second spatial filter for a second PUCCH transmission based at least in part on a second unified TCI state associated with a configured second common beam index of the at least one common beam index. In some embodiments, the method includes determining a first and a second spatial filter for a first PUCCH transmission based at least in part on a first and a second unified TCI state associated with a configured first and second common beam index of the at least one common beam index. In some embodiments, the common beam index configuration indicates an association of the first PUCCH transmission with a first common beam index when a first bit of the common beam index configuration is a first logical value and indicates an association of the first PUCCH transmission with a second common beam index when the first bit of the common beam index configuration is a second logical value. In some embodiments, the common beam index configuration indicates an association of the first PUCCH transmission with a first common beam index and indicates an association with a second PUCCH transmission with a second common beam index when the first bit of the common beam index configuration is a third logical value. In some embodiments, the common beam index configuration indicates an association of the first PUCCH transmission with a first common beam index and with a second common beam index when the first bit of the common beam index configuration is a third logical value. In some embodiments, the method includes receiving the common beam index configuration by radio resource control, RRC, signaling. In some embodiments, each unified TCI state of the plurality of unified TCI states is one of a joint UL/DL TCI state and a separate UL/DL TCI state. In some embodiments, the method includes receiving a medium access control, MAC, control element, CE, to activate a plurality of the unified TCI states for each of at least one codepoint in a TCI field of a downlink control information, DCI, message. In some embodiments, the method includes receiving an indication of a TCI codepoint and activating a plurality of unified TCI states associated with the indicated TCI codepoint. In some embodiments, the method includes assuming a TCI state of the activated unified TCI states for at least one of a downlink, DL, signal and an uplink, UL, signal. In some embodiments, the method includes associating one of a PUCCH resource and a PUCCH resource group with one of a plurality of common beam indices configured by the common beam index configuration. In some embodiments, the method includes associating one of a PUCCH resource and a PUCCH resource group with two of a plurality of common beam indices configured by the common beam index configuration.

According to yet another aspect, a network node configured to communicate with a wireless device, WD, is provided. The network node includes processing circuitry configured to configure a common beam index configuration. The common beam index configuration indicates at least one common beam index, and each of the at least one common beam index is associated with a unified transmission configuration indication, TCI, state of a plurality of unified TCI states. The network node also includes a radio interface in communication with the processing circuitry and configured to transmit the common beam index configuration to the WD.

According to this aspect, in some embodiments, the common beam index configuration includes three different logical values. A first logical value indicates an association to the first unified TCI state of the plurality of unified TCI states, a second logical value indicates an association to a second unified TCI state of the plurality of unified TCI states, and a third logical value indicates an association to both a first and a second unified TCI state of the plurality of unified TCI states. In some embodiments, the common beam index configuration indicates and association of a first PUCCH transmission with a first common beam index when a first bit of the common beam index configuration is a first logical value and indicates an association of the first PUCCH with a second common beam index when the first bit of the common beam index configuration is a second logical value. In some embodiments, the common beam index configuration indicates an association of the first PUCCH transmission with a first common beam index and indicates an association with a second PUCCH transmission with a second common beam index when the first bit of the common beam index configuration is a third logical value. In some embodiments, the common beam index configuration indicates an association of the first PUCCH transmission with a first common beam index and with a second common beam index when the first bit of the common beam index configuration is a third logical value. In some embodiments, the common beam index configuration is transmitted by radio resource control, RRC, signaling. In some embodiments, each unified TCI state of the plurality of unified TCI states is one of a joint UL/DL TCI state and a separate UL/DL TCI state. In some embodiments, the radio interface is further configured to transmit a medium access control, MAC, control element, CE, to activate unified TCI states for each of at least one codepoint in a TCI field of a downlink control information, DCI, message. In some embodiments, the radio interface is further configured to transmit an indication of a TCI codepoint to activate unified TCI states associated with the indicated TCI codepoint. In some embodiments, the processing circuitry is configured to assume a TCI state of the activated unified TCI states for at least one of a downlink, DL, signal and an uplink, UL, signal.

According to another aspect, a method in a network node configured to communicate with a wireless device, WD, is provided. The method includes configuring a common beam index configuration. The common beam index configuration indicates at least one common beam index, and each of the at least one common beam index is associated with a unified transmission configuration indication, TCI, state of a plurality of unified TCI states. The method also includes transmitting the common beam index configuration to the WD.

According the this aspect, in some embodiments, the common beam index configuration includes three different logical values. A first logical value indicates an association to the first unified TCI state of the plurality of unified TCI states, a second logical value indicates an association to a second unified TCI state of the plurality of unified TCI states, and a third logical value indicates an association to both a first and a second unified TCI state of the plurality of unified TCI states. In some embodiments, the common beam index configuration indicates and association of a first PUCCH transmission with a first common beam index when a first bit of the common beam index configuration is a first logical value and indicates an association of the first PUCCH with a second common beam index when the first bit of the common beam index configuration is a second logical value. In some embodiments, the common beam index configuration indicates an association of the first PUCCH transmission with a first common beam index and indicates an association with a second PUCCH transmission with a second common beam index when the first bit of the common beam index configuration is a third logical value. In some embodiments, the common beam index configuration indicates an association of the first PUCCH transmission with a first common beam index and with a second common beam index when the first bit of the common beam index configuration is a third logical value. In some embodiments, the common beam index configuration is transmitted by radio resource control, RRC, signaling. In some embodiments, each unified TCI state of the plurality of unified TCI states is one of a joint UL/DL TCI state and a separate UL/DL TCI state. In some embodiments, the method includes transmitting a medium access control, MAC, control element, CE, to activate unified TCI states for each of at least one codepoint in a TCI field of a downlink control information, DCI, message. In some embodiments, the method includes transmitting an indication of a TCI codepoint to activate unified TCI states associated with the indicated TCI codepoint. In some embodiments, the method includes assuming a TCI state of the activated unified TCI states for at least one of a downlink, DL, signal and an uplink, UL, signal.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates a time slot of 14 symbols;

FIG. 2 illustrates time-frequency resources;

FIG. 3 illustrates sending PUCCH to two TRPs;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node for explicit common beam index configurations for a physical uplink control channel (PUCCH) according to some embodiments of the present disclosure;

FIG. 11 is a flowchart of an example process in a wireless device for explicit common beam index configurations for a physical uplink control channel (PUCCH) according to some embodiments of the present disclosure;

FIG. 12 is a flowchart of an example process in a network node for explicit common beam index configurations for a physical uplink control channel (PUCCH) according to some embodiments of the present disclosure;

FIG. 13 is a flowchart of an example process in a wireless device for explicit common beam index configurations for a physical uplink control channel (PUCCH) according to some embodiments of the present disclosure;

FIG. 14 illustrates an example of 4 TCI states associated with beams; and

FIG. 15 illustrates an example of a relationship between common beam indices and TCI states.

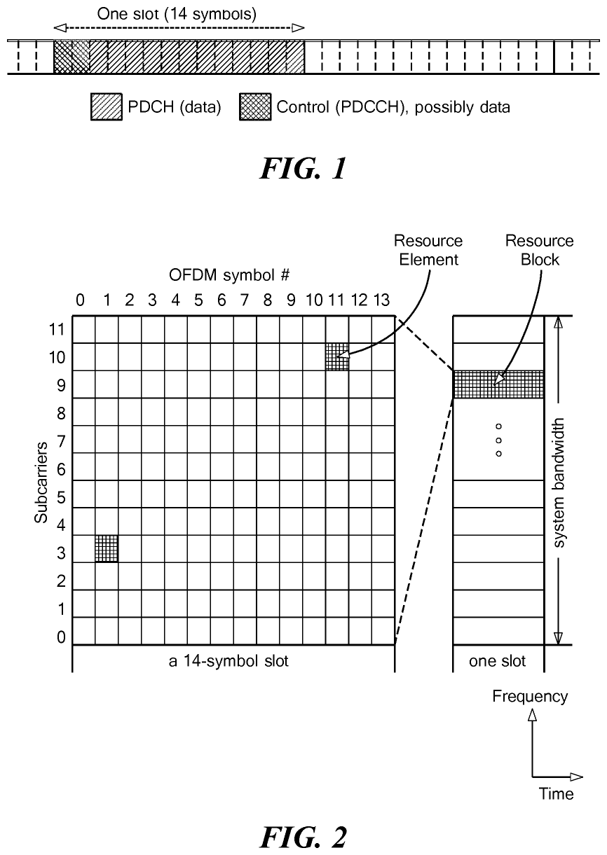

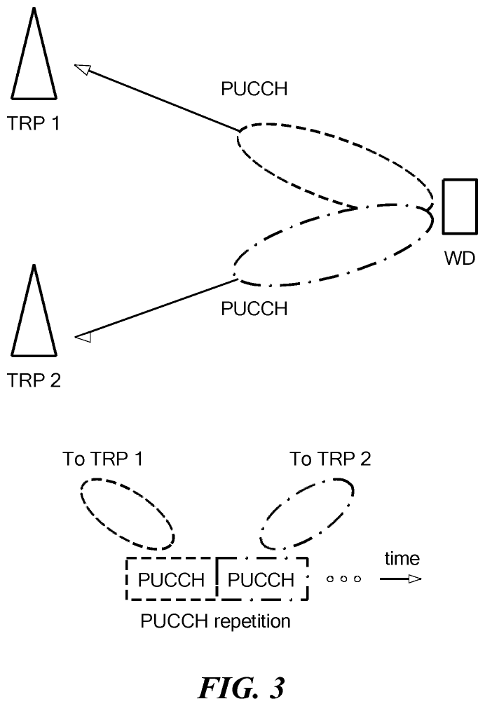

### DETAILED DESCRIPTION

Before describing in detail example embodiments, it is noted that the embodiments reside primarily in combinations of apparatus components and processing steps related to explicit common beam index configurations for a physical uplink control channel (PUCCH). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide explicit common beam index configurations for a physical uplink control channel (PUCCH).

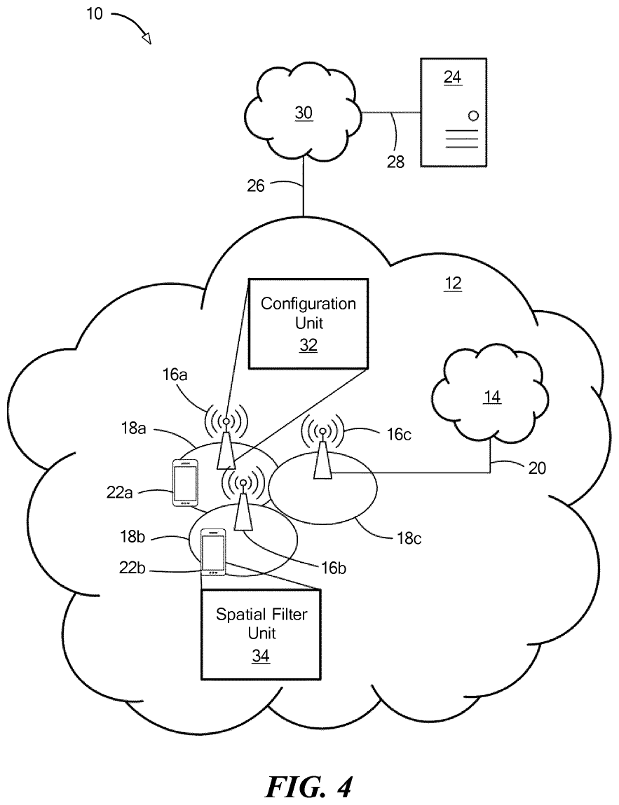

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 configured to configure a WD with at least a first common beam index and a second common beam index, the first common beam index being associated with a first indicated Joint Downlink/Uplink (DL/UL) TCI state, the second common beam index being associated with a second indication Joint DL/UL TCI state. The configuration unit 32 may also be configured to configure a common beam index configuration, the common beam index configuration indicating at least one common beam index, each of the at least one common beam index being associated with a unified transmission configuration indication, TCI, state of a plurality of unified TCI states. A wireless device 22 is configured to include a spatial filter unit 34 which is configured to determining a spatial filter for a first physical uplink control channel, PUCCH, transmission based at least in part on a first configured common beam index and determining a second spatial filter for a second PUCCH transmission based at least in part on the second configured common beam index. The spatial filter unit 34 may also be configured to determine a first spatial filter for a first physical uplink control channel, PUCCH, transmission based at least in part on a first unified TCI state associated with a first common beam index of the at least one common beam index.

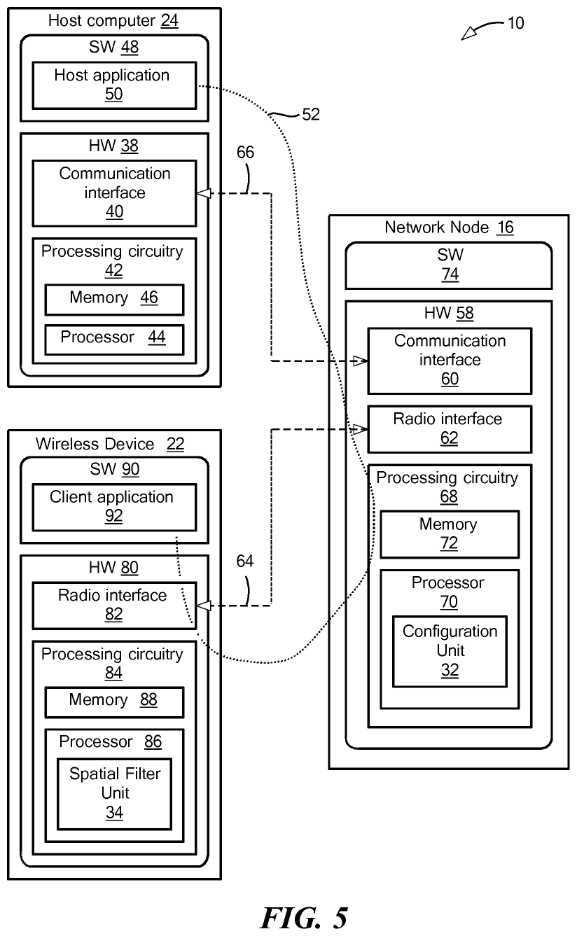

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 configured to configure a WD with at least a first common beam index and a second common beam index, the first common beam index being associated with a first indicated Joint Downlink/Uplink (DL/UL) TCI state, the second common beam index being associated with a second indication Joint DL/UL TCI state. The configuration unit 32 may also be configured to configure a common beam index configuration, the common beam index configuration indicating at least one common beam index, each of the at least one common beam index being associated with a unified transmission configuration indication, TCI, state of a plurality of unified TCI states.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a spatial filter unit 34 which is configured to determining a spatial filter for a first physical uplink control channel, PUCCH, transmission based at least in part on a first configured common beam index and determining a second spatial filter for a second PUCCH transmission based at least in part on the second configured common beam index. The spatial filter unit 34 may also be configured to determine a first spatial filter for a first physical uplink control channel, PUCCH, transmission based at least in part on a first unified TCI state associated with a first common beam index of the at least one common beam index.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as configuration unit 32, and spatial filter unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

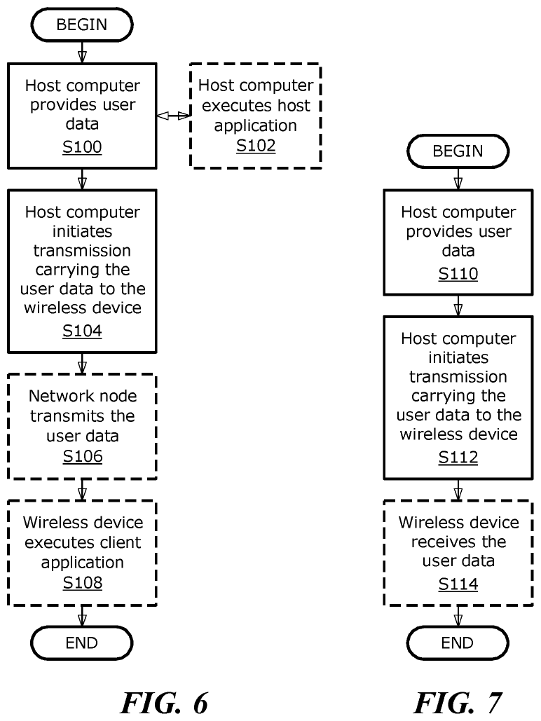

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

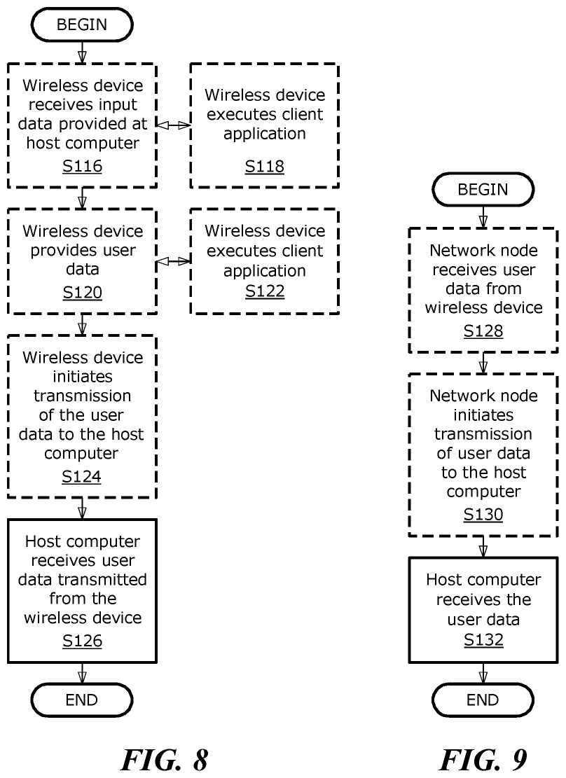

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

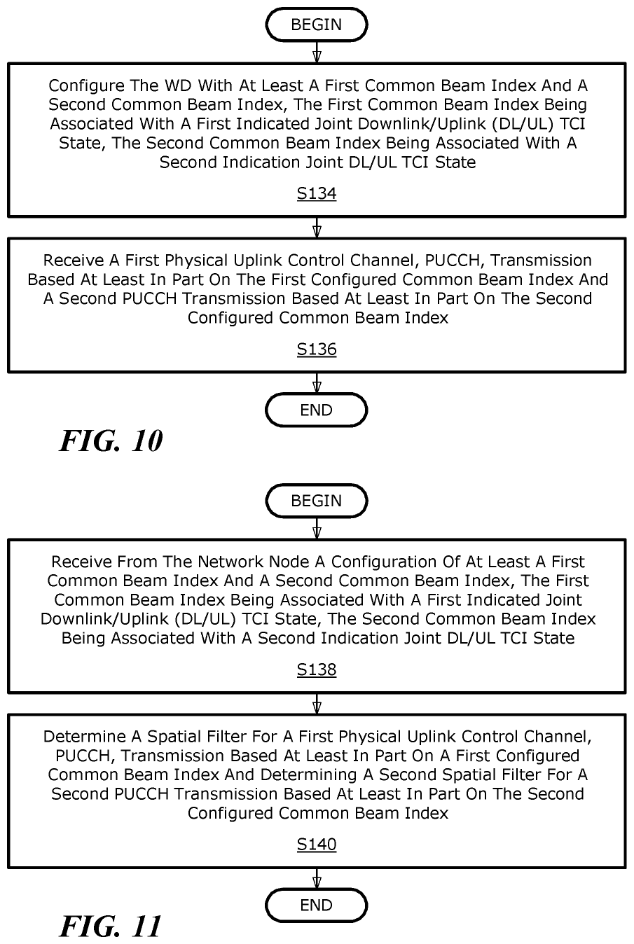

FIG. 10 is a flowchart of an example process in a network node 16 for explicit common beam index configurations for a physical uplink control channel (PUCCH). One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure a WD with at least a first common beam index and a second common beam index, the first common beam index being associated with a first indicated Joint Downlink/Uplink (DL/UL) TCI state, the second common beam index being associated with a second indication Joint DL/UL TCI state (Block S134). The process also includes receiving a first physical uplink control channel, PUCCH, transmission based at least in part on the first configured common beam index and a second PUCCH transmission based at least in part on the second configured common beam index (Block S136).

In some embodiments, the configuration is contained in a Third Generation Partnership Project, 3GPP-defined PUCCH-Resource information element. In some embodiments, the configuration is contained in a Third Generation Partnership Project, 3GPP-defined PUCCH-SpatialRelationInfo information element. In some embodiments, the configuration is per PUCCH resource group. In some embodiments, the configuration includes a flag indicating whether the WD is to use a unified transmission configuration indication, TCI, state framework to derive a spatial filter for multi-transmission reception point, TRP, PUCCH transmission. In some embodiments, the configuration includes a unified transmission configuration indication, TCI, state pointer that associates a PUCCH resource group or a PUCCH resource with one of a plurality of common beam indices.

FIG. 11 is a flowchart of an example process in a wireless device 22 according to some embodiments of the present disclosure. One or more blocks described herein may be performed by one or more elements of wireless device 22 such as by one or more of processing circuitry 84 (including the spatial filter unit 34), processor 86, radio interface 82 and/or communication interface 60. Wireless device 22 such as via processing circuitry 84 and/or processor 86 and/or radio interface 82 is configured to receive from a network node a configuration of at least a first common beam index and a second common beam index, the first common beam index being associated with a first indicated Joint Downlink/Uplink (DL/UL) TCI state, the second common beam index being associated with a second indication Joint DL/UL TCI state (Block S138). The process also includes determining a spatial filter for a first physical uplink control channel, PUCCH, transmission based at least in part on a first configured common beam index and determining a second spatial filter for a second PUCCH transmission based at least in part on the second configured common beam index (Block S140).

In some embodiments, the configuration is received in a Third Generation Partnership Project, 3GPP-defined PUCCH-Resource information element. In some embodiments, the configuration is received in a Third Generation Partnership Project, 3GPP-defined PUCCH-SpatialRelationInfo information element. In some embodiments, the configuration is per PUCCH resource group. In some embodiments, the configuration includes a flag indicating whether the WD uses a unified transmission configuration indication, TCI, state framework to derive a spatial filter for multi-transmission reception point, TRP, PUCCH transmission. In some embodiments, the configuration includes a unified transmission configuration indication, TCI, state pointer that associates a PUCCH resource group or a PUCCH resource with one of a plurality of common beam indices.

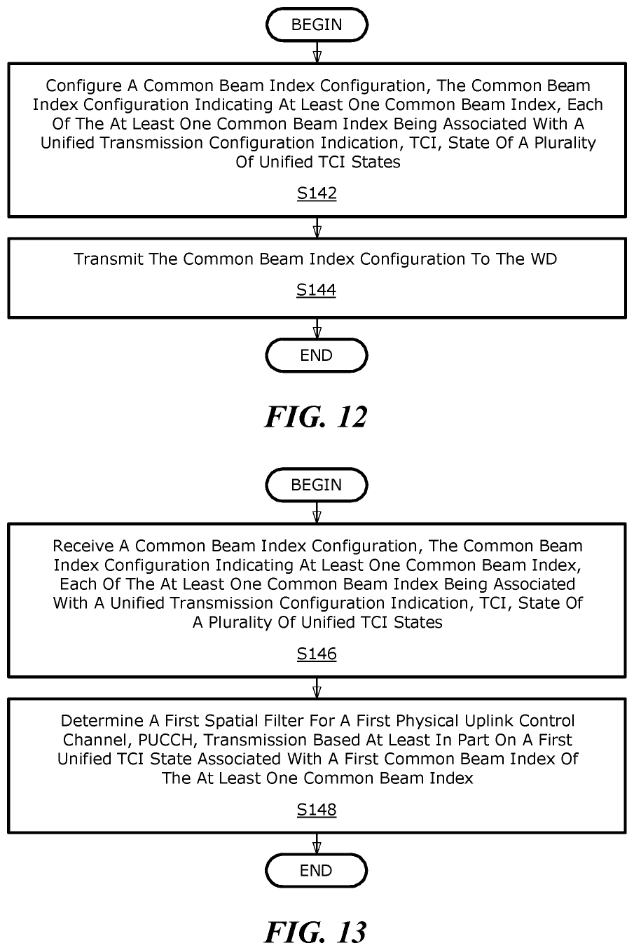

FIG. 12 is a flowchart of an example process in a network node 16 for explicit common beam index configurations for a physical uplink control channel (PUCCH). One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure a common beam index configuration, the common beam index configuration indicating at least one common beam index, each of the at least one common beam index being associated with a unified transmission configuration indication, TCI, state of a plurality of unified TCI states (Block S142). The method also includes transmitting the common beam index configuration to the WD (Block S144).

In some embodiments, the common beam index configuration includes three different logical values, where a first logical value indicates an association to the first unified TCI state of the plurality of unified TCI states, where a second logical value indicates an association to a second unified TCI state of the plurality of unified TCI states, and where a third logical value indicates an association to both a first and a second unified TCI state of the plurality of unified TCI states. In some embodiments, the common beam index configuration indicates and association of a first PUCCH transmission with a first common beam index when a first bit of the common beam index configuration is a first logical value and indicates an association of the first PUCCH with a second common beam index when the first bit of the common beam index configuration is a second logical value. In some embodiments, the common beam index configuration indicates an association of the first PUCCH transmission with a first common beam index and indicates an association with a second PUCCH transmission with a second common beam index when the first bit of the common beam index configuration is a third logical value. In some embodiments, the common beam index configuration indicates an association of the first PUCCH transmission with a first common beam index and with a second common beam index when the first bit of the common beam index configuration is a third logical value. In some embodiments, the common beam index configuration is transmitted by radio resource control, RRC, signaling. In some embodiments, each unified TCI state of the plurality of unified TCI states is one of a joint UL/DL TCI state and a separate UL/DL TCI state. In some embodiments, the method includes transmitting a medium access control, MAC, control element, CE, to activate unified TCI states for each of at least one codepoint in a TCI field of a downlink control information, DCI, message. In some embodiments, the method includes transmitting an indication of a TCI codepoint to activate unified TCI states associated with the indicated TCI codepoint. In some embodiments, the method includes assuming a TCI state of the activated unified TCI states for at least one of a downlink, DL, signal and an uplink, UL, signal.

FIG. 13 is a flowchart of an example process in a wireless device 22 according to some embodiments of the present disclosure. One or more blocks described herein may be performed by one or more elements of wireless device 22 such as by one or more of processing circuitry 84 (including the spatial filter unit 34), processor 86, radio interface 82 and/or communication interface 60. Wireless device 22 such as via processing circuitry 84 and/or processor 86 and/or radio interface 82 is configured to receive a common beam index configuration, the common beam index configuration indicating at least one common beam index, each of the at least one common beam index being associated with a unified transmission configuration indication, TCI, state of a plurality of unified TCI states (Block S146). The method also includes determining a first spatial filter for a first physical uplink control channel, PUCCH, transmission based at least in part on a first unified TCI state associated with a first common beam index of the at least one common beam index (Block S148).

According to this aspect, in some embodiments, the common beam index configuration includes three different logical values. A first logical value indicates an association to the first unified TCI state of the plurality of unified TCI states, a second logical value indicates an association to a second unified TCI state of the plurality of unified TCI states, and a third logical value indicates an association to both a first and a second unified TCI state of the plurality of unified TCI states. In some embodiments, the method includes determining a second spatial filter for a second PUCCH transmission based at least in part on a second unified TCI state associated with the second common beam index of the at least one common beam index. In some embodiments, the method includes determining a first spatial filter for a first PUCCH transmission based at least in part on a first unified TCI state associated with a configured first common beam index of the at least one common beam index and determining a second spatial filter for a second PUCCH transmission based at least in part on a second unified TCI state associated with a configured second common beam index of the at least one common beam index. In some embodiments, the method includes determining a first and a second spatial filter for a first PUCCH transmission based at least in part on a first and a second unified TCI state associated with a configured first and second common beam index of the at least one common beam index. In some embodiments, the common beam index configuration indicates an association of the first PUCCH transmission with a first common beam index when a first bit of the common beam index configuration is a first logical value and indicates an association of the first PUCCH transmission with a second common beam index when the first bit of the common beam index configuration is a second logical value. In some embodiments, the common beam index configuration indicates an association of the first PUCCH transmission with a first common beam index and indicates an association with a second PUCCH transmission with a second common beam index when the first bit of the common beam index configuration is a third logical value. In some embodiments, the common beam index configuration indicates an association of the first PUCCH transmission with a first common beam index and with a second common beam index when the first bit of the common beam index configuration is a third logical value. In some embodiments, the method includes receiving the common beam index configuration by radio resource control, RRC, signaling. In some embodiments, each unified TCI state of the plurality of unified TCI states is one of a joint UL/DL TCI state and a separate UL/DL TCI state. In some embodiments, the method includes receiving a medium access control, MAC, control element, CE, to activate a plurality of the unified TCI states for each of at least one codepoint in a TCI field of a downlink control information, DCI, message. In some embodiments, the method includes receiving an indication of a TCI codepoint and activating a plurality of unified TCI states associated with the indicated TCI codepoint. In some embodiments, the method includes assuming a TCI state of the activated unified TCI states for at least one of a downlink, DL, signal and an uplink, UL, signal. In some embodiments, the method includes associating one of a PUCCH resource and a PUCCH resource group with one of a plurality of common beam indices configured by the common beam index configuration. In some embodiments, the method includes associating one of a PUCCH resource and a PUCCH resource group with two of a plurality of common beam indices configured by the common beam index configuration.

Having described the general process flow of arrangements of the disclosure and having provided examples of hardware and software arrangements for implementing the processes and functions of the disclosure, the sections below provide details and examples of arrangements for explicit common beam index configurations for a physical uplink control channel (PUCCH).

In the following embodiments, the term ‘common beam index’ is used. A common beam index can be understood to be an identifier or ID of an activated or indicated Joint DL/UL TCI state. In some other cases, a common beam index can be understood to be an identifier or ID of an activated or indicated separate UL TCI state (i.e., UL-only TCI state). Note that the term TRP may not be captured in 3GPP specifications. In some embodiments disclosed herein, a TRP may be represented by a Unified TCI state as defined above (which can be either a Joint DL/UL TCI state or an UL TCI state).

To support mTRP PUCCH transmissions with unified TCI states, it is envisioned that multiple unified TCI states may be indicated/activated using a combination of RRC signaling, MAC CE signaling and/or DCI indication. One or more of the following steps may be performed:
Step 1: A WD 22 is RRC configured with a list of unified TCI states, each associated with a source RS from which a beam or spatial filter is to be derived by the WD 22, where the maximum number N_{max,TCI} of unified TCI states can be configured:
   TCI state 0
   TCI state 1
   . . .
   TCI state N_{max,TCI}-1;
Step 2: MAC CE activates multiple TCI states out of the list of unified TCI states for each TCI codepoint in DCI, where M is the number of TCI codepoints of a TCI field in DCI, Lᵢ is the number of activated TCI states for the ith TCI codepoint of the TCI field in DCI, and k_{i,j} ∈{0,1, . . . , N_{max,TCI}-1}:
   {TCI state k_{0,1}, TCI state k_{0,2}, . . . , TCI state k_{0,L}_{₀},} for TCI codepoint 0
   {TCI state k_{1,1}, TCI state k_{1,2}, . . . , TCI state k_{1,L}_{₁},} for TCI codepoint 1
   . . .
   {TCI state k_{M-1,1}, TCI state k_{M-1,2}, . . . , TCI state k_{M-1,L}_{_{M-1}}} for TCI codepoint M-1;
Step 3: One of the TCI codepoints is signaled to the WD via DCI. The corresponding TCI states are to be used for subsequent DL and/or UL transmissions; and/or
Step 4: The WD 22 sends a HARQ-ACK to acknowledge the reception of the DCI. After a certain time period (e.g., Y symbols) of receiving the DCI, the TCI states associated with the TCI codepoint are assumed for certain DL and/or UL channels or signals.

Steps 3 & 4 above may be repeated by signaling a different TCI codepoint if a new set of activated TCI states is needed due to, for example, WD movement. Steps 2, 3 & 4 may be repeated if new TCI states need to be activated.

Each of the unified TCI states can be either a joint DL/UL TCI state or a separate DL/UL TCI state as defined in NR 3GPP Rel-17.

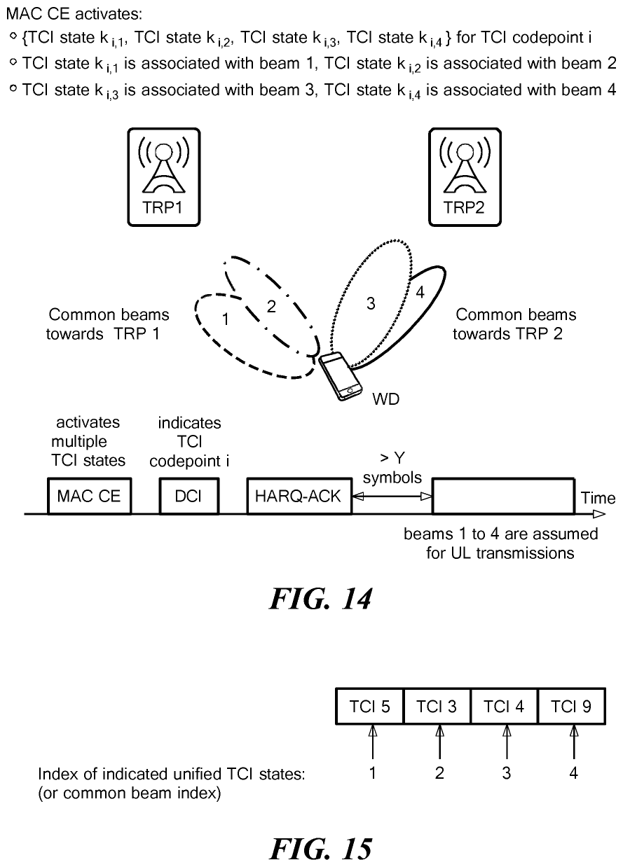

An example is illustrated in FIG. 14, where 4 unified TCI states are activated by a MAC CE for a TCI codepoint, each of the 4 TCI states being associated with a beam (or a spatial filter) towards one of two TRPs.

In the following, assume that a list of unified TCI states are activated by a MAC CE for each TCI codepoint in DCI. A unified TCI state in the list can be referred simply by its position in the list. One example is provided in FIG. 15, where four unified TCI states are activated for a TCI codepoint that is indicated in DCI and the first unified TCI state is TCI state 5, the second unified TCI state is TCI state 3, and so on.

In the following, unified TCI states associated with the indicated TCI codepoint in DCI are referred to as activated/indicated unified TCI states. The terms of activated/indicated unified TCI states, activated unified TCI states, indicated unified TCI states, indicated TCI states, indicated unified TCI state, and common beams may be used interchangeably.

### Embodiments Where Common Beam Indices are Configured in a PUCCH-Resource

In one embodiment, one or two common beam or activated/indicated unified TCI state indices can be explicitly configured for each PUCCH-Resource (as specified in 3GPP Technical Standard (TS) 38.331 e.g. v16.7.0) as schematically illustrated in FIG. 15.

In one embodiment, in case the Common_beam_index is configured with “commonBeam1” in a PUCCH resource and the WD is indicated with two unified TCI states, the WD may determine the spatial filter for the PUCCH resource based on a first indicated unified TCI state. In a similar way, in case the Common_beam_index is configured with “commonBeam2” and the WD is indicated with two unified TCI states, the WD may determine the spatial filter for the transmitted PUCCH resource based on a second indicated unified TCI state. In case the Common_beam_index is configured with “commonBeam1ANDcommonBeam2” and the WD 22 is indicated with two unified TCI states, the WD may determine the spatial filter for a first PUCCH transmission occasion in the PUCCH resource based on a first indicated unified TCI state and a second PUCCH transmission occasion in the PUCCH resource based on a second unified TCI state.

In one embodiment, in cases where the WD 22 is indicated with one unified TCI state, the WD may ignore field, and follow the indicated unified TCI state.

| PUCCH-Resource ::= | SEQUENCE { |
|---|---|
| [[ | |
| Common_beam_index | ENUMERATED {commonBeam1, |

```
commonBeam2,commonBeam1ANDcommonBeam2}
  ]]
  }
```

When the WD 22 is configured with commonBeam1ANDcommonBeam2, it may be determined which PUCCH transmission should be associated with which common beam index, for different PUCCH transmission modes.

In some embodiments, in case PUCCH is scheduled for time division multiplex (TDM)/frequency division multiplex (FDM) repetition (i.e., where the same payload is transmitted in two different PUCCH transmission occasions in different times or in the same time but different frequency resources), the first PUCCH repetition may be associated with a first common beam index (i.e., a first indicated unified TCI state), and the second PUCCH repetition is associated with a second common beam index (i.e., a second indicated unified TCI state). In one embodiment, a codepoint in DCI for scheduling the PUCCH can be used to change the order of the association between common beam index and first/second PUCCH transmission. For example, in case the codepoint is ‘0’, the WD 22 may associate a first common beam index with the first PUCCH repetition (or transmission) and a second common beam index with the second PUCCH repetition (or transmission). In case the codepoint is ‘1’, the WD may associate a second common beam index with the first PUCCH repetition and a first common beam index with the second PUCCH repetition. Note that the codepoints could be included in another bitfield in the DCI used for other purposes.

In some embodiments, if there are more than two unified TCI states or common beams indicated, a unified TCI state pointer pointing to one or two of the indicated unified TCI states or common beams may be configured in a PUCCH resource. For example, if up to 4 unified TCI states may be indicated in a TCI codepoint in DCI, 4 indices {1^{st}, 2^{nd}, 3^{rd}, 4^{th}} may be used to indicate the 4 unified TCI states, respectively. An pointer may be configured in a PUCCH resource to point to one or two of the 4 unified TCI states by referring to the indices.

The benefit of configuring a unified TCI state pointer instead of unified TCI states in a PUCCH resource is that the configuration can remain the same without change when different unified TCI states may be indicated at different times. The spatial filter(s) for the PUCCH may always follow the common beam(s) associated with the indicated unified TCI states.

In some embodiments, a unified TCI state pointer may be configured for a group of PUCCH resources to indicate one or two indicated unified TCI states for all PUCCH resources in a PUCCH group. An example is shown below, where the parameter “Unified-TCI-State-Pointer” indicates one of the indicated unified TCI states and the parameter “unified-TCI-State-Pointer-List” is configured in each PUCCH group and indicates one or more of the indicated unified TCI states by containing one or more Unified-TCI-State-Pointers.

| | |
|---|---|
| PUCCH-ResourceGroup-r16 ::= | SEQUENCE { |
| pucch-ResourceGroupId-r16 | PUCCH-ResourceGroupId- |

r16,

| | |
|---|---|
| resourcePerGroupList-r16 | SEQUENCE (SIZE |

(1..maxNrofPUCCH-ResourcesPerGroup-r16)) OF PUCCH-ResourceId

| | |
|---|---|
| unified-TCI-State-Pointer-List | SEQUENCE (SIZE(1.. |

maxNrofTCI-State-Pointers)) OF Unified-TCI-State-Pointer
}

| | |
|---|---|
| PUCCH-ResourceGroupId-r16 ::= | INTEGER |

(0..maxNrofPUCCH-ResourceGroups-1-r16)

| | |
|---|---|
| Unified-TCI-State-Pointer ::= | INTEGER |

(1..maxNrofIndicated-TCI-States)

### Embodiments Where Common Beam Indices Are Configured in PUCCH-SpatialRelationInfo Information Element

In some embodiments, a common beam index can be explicitly configured in PUCCH-SpatialRelationInfo information element (as specified in 3GPP Technical Standard (TS) 38.331 e.g. v16.7.0) as set forth below. A MAC-CE can then be used to associate one or two spatial relations with a PUCCH resource, and in this way associate one or two common beam indices with a PUCCH resource.

In some embodiments, in case the Common_beam_index in a PUCCH-SpatialRelationInfo IE is configured with commonBeam1, and a MAC-CE has associated/activated the PUCCH-SpatialRelationInfo IE for a PUCCH resource, and the WD 22 is indicated with two Unified TCI states, the WD 22 may determine the spatial filter for the transmitted PUCCH resource based on a first indicated Unified TCI state.

In a similar way, in case the Common_beam_index in a PUCCH-SpatialRelationInfo IE is configured with commonBeam2, and a MAC-CE has associated/activated the PUCCH-SpatialRelationInfo IE for a PUCCH resource, and the WD 22 is indicated with two Unified TCI states, the WD 22 may determine the spatial filter for the transmitted PUCCH resource based on a second indicated Unified TCI state.

In case the Common_beam_index in a first PUCCH-SpatialRelationInfo IE is configured with commonBeam1, and a Common_beam_index in a second PUCCH-SpatialRelationInfo IE is configured with commonBeam2, and a MAC-CE has associated/activated the first and the second PUCCH-SpatialRelationInfo IE for a PUCCH resource, and the WD 22 is indicated with two Unified TCI states, the WD 22 may determine the spatial filter for a first transmission of the PUCCH resource based on a first indicated Unified TCI state and a second transmission of the PUCCH resource based on a second Unified TCI state.

| | |
|---|---|
| PUCCH-SpatialRelationInfo ::= | SEQUENCE { |
| pucch-SpatialRelationInfoId | PUCCH-SpatialRelationInfoId |

[[

| | |
|---|---|
| Common_beam_index | ENUMERATED {commonBeam1, |

```
commonBeam2}
  ]]
  }
```

In case a WD 22 is triggered with transmission of a PUCCH resource that is activated or configured with a first spatial relation configured with a first common beam index (e.g. commonBeam1) and a second spatial relation configured with a second common beam index (e.g. commonBeam2), the WD 22 may need to know which common beam index to associate with which PUCCH transmission.

In some embodiments, the WD 22 associates the first PUCCH transmission with the common beam index configured in a first spatial relation (for example the spatial relation with lower pucch-SpatialRelationInfoId among the activated/configured spatial relations) and the WD 22 associates the second PUCCH transmission with the common beam index configured in a second spatial relation. For example the spatial relation with highest pucch-SpatialRelationInfoId among the activated/configured spatial relations.

In some embodiments, a flag parameter may be configured as part of PUCCH-Config along with multi-TRP PUCCH configuration parameters. This flag parameter enables the use of the unified TCI state to be used for multi-TRP PUCCH schemes. If the flag parameter is not configured, then the WD 22 may assume the 3GPP Rel-15/16 based spatial relation framework for mTRP PUCCH transmission. For instance, if the flag parameter is configured, then the WD 22 may be instructed to assume unified TCI state(s) for deriving spatial filters for multi-TRP PUCCH schemes. If the flag is not configured, the WD 22 may be instructed to use spatial relations that are either activated or configured to the PUCCH resource associated with the multi-TRP PUCCH transmission to derive the spatial filter for multi-TRP PUCCH transmission. The multi-TRP PUCCH configuration parameters may include configuration parameters for a PUCCH mapping pattern which can take on values of either ‘cyclic mapping’ or ‘sequential mapping’. Assuming PUCCH transmission across 4 repetitions with two spatial relations or two unified TCI states, for example, ‘cyclic mapping’ may take on the following meaning:
If the flag parameter is enabled, then PUCCH transmissions in repetitions 1 and 3 use the spatial filters derived using the source RS in the first indicated unified TCI state. The PUCCH transmissions in repetitions 2 and 4 use the spatial filters derived using the source RS in the second indicated unified TCI state.
If the flag parameter is disabled, then PUCCH transmissions in repetitions 1 and 3 use the spatial filters derived using the source RS in the first spatial relation activated/configured to the PUCCH resource associated with the multi-TRP PUCCH transmission. The PUCCH transmissions in repetitions 2 and 4 use the spatial filters derived using the source RS in the second spatial relation activated/configured to the PUCCH resource associated with the multi-TRP PUCCH transmission.

Assuming PUCCH transmission across 4 repetitions with two spatial relations or two unified TCI states, for example, ‘sequential mapping’ may take on the following meaning:
If the flag parameter is enabled, then PUCCH transmissions in repetitions 1 and 2 use the spatial filters derived using the source RS in the first indicated unified TCI state. The PUCCH transmissions in repetitions 3 and 4 use the spatial filters derived using the source RS in the second indicated unified TCI state.
If the flag parameter is disabled, then PUCCH transmissions in repetitions 1 and 2 use the spatial filters derived using the source RS in the first spatial relation activated/configured to the PUCCH resource associated with the multi-TRP PUCCH transmission. The PUCCH transmissions in repetitions 3 and 4 use the spatial filters derived using the source RS in the second spatial relation activated/configured to the PUCCH resource associated with the multi-TRP PUCCH transmission.

In some embodiments, the flag parameter may be optional which means that if the flag parameter is present in PUCCH-Config, then the use of the unified TCI state to be used for multi-TRP PUCCH schemes is enabled. When the flag parameter is not present in PUCCH-Config, then the use of the spatial relations activated/configured to the PUCCH resources associated with the multi-TRP PUCCH transmission is assumed.

Some embodiments may include one or more of the following:
Embodiment 1. A method in a WD 22 for determining spatial filter for PUCCH transmission using the Unified TCI state framework for mTRP operation, where the method includes:
   a. Receiving explicit configuration of one or more common beam indices, where a first common beam index is associated with a first indicated Joint DL/UL TCI state and a second common beam index is associated with a second indicated Joint DL/UL TCI states; and
   b. Determine a first spatial filter for a first PUCCH transmission based on a first explicitly configured common beam index, and determining a second spatial filter for a second PUCCH transmission based on a second explicitly configured common beam index.
2. Embodiment 1 and where the explicit configuration is done in PUCCH-Resource (as specified in 3GPP TS 38.331 e.g. v16.7.0).
3. Embodiment 1 and where the explicit configuration is done in PUCCH-SpatialRelationInfo information element (as specified in 3GPP TS 38.331 e.g. v16.7.0).
4. Embodiment 1 where the explicit configuration is done in each PUCCH resource group.
5. Embodiment 1 and where an additional flag is configured in PUCCH config, and only if the flag is configured, should the WD 22 use the unified TCI state framework to derive the spatial filter for mTRP PUCCH transmission (otherwise the WD 22 should use the legacy 3GPP Rel-15/16 TCI state framework to determine the spatial filters).
6. Any above and where a Unified-TCI-State-Pointer is introduced to explicitly associate a PUCCH resource or PUCCH resource group with one out of M (where M can be 2 or more) common beam indices (useful in case for example more than 2 TCI states can be indicated in DCI)

Some embodiments may include one or more of the following:
Embodiment A1. A network node configured to communicate with a wireless device (WD), the network node configured to, and/or comprising a radio interface and/or comprising processing circuitry configured to:
configure the WD with at least a first common beam index and a second common beam index, the first common beam index being associated with a first indicated Joint Downlink/Uplink (DL/UL) TCI state, the second common beam index being associated with a second indication Joint DL/UL TCI state; and
receive a first physical uplink control channel, PUCCH, transmission based at least in part on the first configured common beam index and a second PUCCH transmission based at least in part on the second configured common beam index.
Embodiment A2. The network node of Embodiment A1, wherein the configuration is contained in a Third Generation Partnership Project, 3GPP-defined PUCCH-Resource information element.
Embodiment A3. The network node of Embodiment A1, wherein the configuration is contained in a Third Generation Partnership Project, 3GPP-defined PUCCH-SpatialRelationInfo information element.
Embodiment A4. The network node of Embodiment A1, wherein the configuration is per PUCCH resource group.
Embodiment A5. The network node of any of Embodiments A1-A4, wherein the configuration includes a flag indicating whether the WD is to use a unified transmission configuration indication, TCI, state framework to derive a spatial filter for multi-transmission reception point, TRP, PUCCH transmission.
Embodiment A6. The network node of any of Embodiments A1-A5, wherein the configuration includes a unified transmission configuration indication, TCI, state pointer that associates a PUCCH resource group or a PUCCH resource with one of a plurality of common beam indices.
Embodiment B1. A method implemented in a network node, the method comprising:
configuring a WD with at least a first common beam index and a second common beam index, the first common beam index being associated with a first indicated Joint Downlink/Uplink (DL/UL) TCI state, the second common beam index being associated with a second indication Joint DL/UL TCI state; and
receiving a first physical uplink control channel, PUCCH, transmission based at least in part on the first configured common beam index and a second PUCCH transmission based at least in part on the second configured common beam index.
Embodiment B2. The method of Embodiment B1, wherein the configuration is contained in a Third Generation Partnership Project, 3GPP-defined PUCCH-Resource information element.
Embodiment B3. The method of Embodiment B1, wherein the configuration is contained in a Third Generation Partnership Project, 3GPP-defined PUCCH-SpatialRelationInfo information element.
Embodiment B4. The method of Embodiment B1, wherein the configuration is per PUCCH resource group.
Embodiment B5. The method of any of Embodiments B1-B4, wherein the configuration includes a flag indicating whether the WD is to use a unified transmission configuration indication, TCI, state framework to derive a spatial filter for multi-transmission reception point, TRP, PUCCH transmission.
Embodiment B6. The method of any of Embodiments B1-B5, wherein the configuration includes a unified transmission configuration indication, TCI, state pointer that associates a PUCCH resource group or a PUCCH resource with one of a plurality of common beam indices.
Embodiment C1. A wireless device (WD) configured to communicate with a network node, the WD configured to, and/or comprising a radio interface and/or processing circuitry configured to:
receive from the network node a configuration of at least a first common beam index and a second common beam index, the first common beam index being associated with a first indicated Joint Downlink/Uplink (DL/UL) TCI state, the second common beam index being associated with a second indication Joint DL/UL TCI state; and
determine a spatial filter for a first physical uplink control channel, PUCCH, transmission based at least in part on a first configured common beam index and determining a second spatial filter for a second PUCCH transmission based at least in part on the second configured common beam index.
Embodiment C2. The WD of Embodiment C1, wherein the configuration is received in a Third Generation Partnership Project, 3GPP-defined PUCCH-Resource information element.
Embodiment C3. The WD of Embodiment C1, wherein the configuration is received in a Third Generation Partnership Project, 3GPP-defined PUCCH-SpatialRelationInfo information element.
Embodiment C4. The WD of Embodiment C1, wherein the configuration is per PUCCH resource group.
Embodiment C5. The WD of any of Embodiments C1-C4, wherein the configuration includes a flag indicating whether the WD uses a unified transmission configuration indication, TCI, state framework to derive a spatial filter for multi-transmission reception point, TRP, PUCCH transmission.
Embodiment C6. The WD of any of Embodiments C1-C5, wherein the configuration includes a unified transmission configuration indication, TCI, state pointer that associates a PUCCH resource group or a PUCCH resource with one of a plurality of common beam indices.
Embodiment D1. A method implemented in a wireless device (WD), the method:
receiving from a network node a configuration of at least a first common beam index and a second common beam index, the first common beam index being associated with a first indicated Joint Downlink/Uplink (DL/UL) TCI state, the second common beam index being associated with a second indication Joint DL/UL TCI state; and
determining a spatial filter for a first physical uplink control channel, PUCCH, transmission based at least in part on a first configured common beam index and determining a second spatial filter for a second PUCCH transmission based at least in part on the second configured common beam index.
Embodiment D2. The method of Embodiment D1, wherein the configuration is received in a Third Generation Partnership Project, 3GPP-defined PUCCH-Resource information element.
Embodiment D3. The method of Embodiment D1, wherein the configuration is received in a Third Generation Partnership Project, 3GPP-defined PUCCH-SpatialRelationInfo information element.
Embodiment D4. The method of Embodiment D1, wherein the configuration is per PUCCH resource group.
Embodiment D5. The method of any of Embodiments D1-D4, wherein the configuration includes a flag indicating whether the WD uses a unified transmission configuration indication, TCI, state framework to derive a spatial filter for multi-transmission reception point, TRP, PUCCH transmission.
Embodiment D6. The method of any of Embodiments D1-D5, wherein the configuration includes a unified transmission configuration indication, TCI, state pointer that associates a PUCCH resource group or a PUCCH resource with one of a plurality of common beam indices.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-50. (canceled)

51. A wireless device (WD) configured to communicate with a network node, the WD comprising:
a radio interface configured to receive a common beam index configuration, the common beam index configuration indicating at least one common beam index, each of the at least one common beam index being associated with a unified transmission configuration indication (TCI) state of a plurality of unified TCI states; and
processing circuitry in communication with the radio interface and configured to determine a first spatial filter for a first physical uplink control channel (PUCCH) transmission based at least in part on a first unified TCI state associated with a first common beam index of the at least one common beam index, wherein a first logical value of the common beam index configuration indicates an association to the first unified TCI state of the plurality of unified TCI states, a second logical value of the common beam index configuration indicates an association to a second unified TCI state of the plurality of unified TCI states, and a third logical value of the common beam index configuration indicates an association to both a first and a second unified TCI state of the plurality of unified TCI states.

52. The WD of claim 51, wherein the processing circuitry is further configured to determine a second spatial filter for a second PUCCH transmission based at least in part on a second unified TCI state associated with the second common beam index of the at least one common beam index.

53. The WD of claim 51, wherein the processing circuitry is further configured to determine a first spatial filter for a first PUCCH transmission based at least in part on a first unified TCI state associated with a configured first common beam index of the at least one common beam index and determining a second spatial filter for a second PUCCH transmission based at least in part on a second unified TCI state associated with a configured second common beam index of the at least one common beam index.

54. The WD of claim 51, wherein the processing circuitry is further configured to determine a first and a second spatial filter for a first PUCCH transmission based at least in part on a first and a second unified TCI state associated with a configured first and second common beam index of the at least one common beam index.

55. The WD of claim 51, wherein the common beam index configuration indicates an association of the first PUCCH transmission with a first common beam index when a first bit of the common beam index configuration is a first logical value and indicates an association of the first PUCCH transmission with a second common beam index when the first bit of the common beam index configuration is a second logical value.

56. The WD of claim 51, wherein the processing circuitry is further configured to receive the common beam index configuration by radio resource control (RRC) signaling.

57. The WD of claim 51, wherein each unified TCI state of the plurality of unified TCI states is one of a joint UL/DL TCI state and a separate UL/DL TCI state.

58. The WD of claim 51, wherein the processing circuitry is further configured to:
receive a medium access control (MAC) control element (CE) to activate a plurality of the unified TCI states for each of at least one codepoint in a TCI field of a downlink control information (DCI) message; or
receive an indication of a TCI codepoint and activate a plurality of unified TCI states associated with the indicated TCI codepoint.

59. The WD of claim 58, wherein the processing circuitry is further configured to assume a TCI state of the activated unified TCI states for at least one of a downlink (DL) signal and an uplink (UL) signal.

60. The WD of claim 51, wherein the processing circuitry is further configured to:
associate one of a PUCCH resource and a PUCCH resource group with one of a plurality of common beam indices configured by the common beam index configuration; or
associate one of a PUCCH resource and a PUCCH resource group with two of a plurality of common beam indices configured by the common beam index configuration.

61. A method in a wireless device (WD) configured to communicate with a network node, the method comprising:
receiving a common beam index configuration, the common beam index configuration indicating at least one common beam index, each of the at least one common beam index being associated with a unified transmission configuration indication (TCI) state of a plurality of unified TCI states; and
determining a first spatial filter for a first physical uplink control channel (PUCCH) transmission based at least in part on a first unified TCI state associated with a first common beam index of the at least one common beam index, wherein a first logical value of the common beam index configuration indicates an association to the first unified TCI state of the plurality of unified TCI states, a second logical value of the common beam index configuration indicates an association to a second unified TCI state of the plurality of unified TCI states, and a third logical value the common beam index configuration indicates an association to both a first and a second unified TCI state of the plurality of unified TCI states.

62. The method of claim 61, further comprising determining a second spatial filter for a second PUCCH transmission based at least in part on a second unified TCI state associated with the second common beam index of the at least one common beam index.

63. The method of claim 61, further comprising determining a first spatial filter for a first PUCCH transmission based at least in part on a first unified TCI state associated with a configured first common beam index of the at least one common beam index and determining a second spatial filter for a second PUCCH transmission based at least in part on a second unified TCI state associated with a configured second common beam index of the at least one common beam index.

64. The method of claim 61, further comprising determining a first and a second spatial filter for a first PUCCH transmission based at least in part on a first and a second unified TCI state associated with a configured first and second common beam index of the at least one common beam index.

65. The method of claim 61, wherein the common beam index configuration indicates an association of the first PUCCH transmission with a first common beam index when a first bit of the common beam index configuration is a first logical value and indicates an association of the first PUCCH transmission with a second common beam index when the first bit of the common beam index configuration is a second logical value.

66. The method of claim 61, further comprising receiving the common beam index configuration by radio resource control (RRC) signaling.

67. The method of claim 61, wherein each unified TCI state of the plurality of unified TCI states is one of a joint UL/DL TCI state and a separate UL/DL TCI state.

68. The method of claim 61, further comprising:
receiving a medium access control (MAC) control element (CE) to activate a plurality of the unified TCI states for each of at least one codepoint in a TCI field of a downlink control information (DCI) message; or
receiving an indication of a TCI codepoint and activating a plurality of unified TCI states associated with the indicated TCI codepoint.

69. The method of claim 68, further comprising assuming a TCI state of the activated unified TCI states for at least one of a downlink (DL) signal and an uplink (UL) signal.

70. The method of claim 61, further comprising:
associating one of a PUCCH resource and a PUCCH resource group with one of a plurality of common beam indices configured by the common beam index configuration; or
associating one of a PUCCH resource and a PUCCH resource group with two of a plurality of common beam indices configured by the common beam index configuration.

71. A network node configured to communicate with a wireless device (WD), the network node comprising:
processing circuitry configured to configure a common beam index configuration, the common beam index configuration indicating at least one common beam index, each of the at least one common beam index being associated with a unified transmission configuration indication (TCI) state of a plurality of unified TCI states; and
a radio interface in communication with the processing circuitry and configured to transmit the common beam index configuration to the WD, wherein a first logical value of the common beam index configuration indicates an association to the first unified TCI state of the plurality of unified TCI states, a second logical value the common beam index configuration indicates an association to a second unified TCI state of the plurality of unified TCI states, and a third logical value of the common beam index configuration indicates an association to both a first and a second unified TCI state of the plurality of unified TCI states.

72. The network node of claim 71, wherein the common beam index configuration indicates and association of a first PUCCH transmission with a first common beam index when a first bit of the common beam index configuration is a first logical value and indicates an association of the first PUCCH with a second common beam index when the first bit of the common beam index configuration is a second logical value.

73. The network node of claim 71, wherein the common beam index configuration is transmitted by radio resource control (RRC) signaling.

74. The network node of claim 71, wherein each unified TCI state of the plurality of unified TCI states is one of a joint UL/DL TCI state and a separate UL/DL TCI state. cm 75. The network node of claim 71, wherein the processing circuitry is further configured to:
transmit a medium access control (MAC) control element (CE) to activate unified TCI states for each of at least one codepoint in a TCI field of a downlink control information (DCI) message; or
transmit an indication of a TCI codepoint to activate unified TCI states associated with the indicated TCI codepoint.

76. A method in a network node configured to communicate with a wireless device (WD), the method comprising:
configuring a common beam index configuration, the common beam index configuration indicating at least one common beam index, each of the at least one common beam index being associated with a unified transmission configuration indication (TCI) state of a plurality of unified TCI states; and
transmitting the common beam index configuration to the WD, wherein a first logical value of the common beam index configuration indicates an association to the first unified TCI state of the plurality of unified TCI states, a second logical value of the common beam index configuration indicates an association to a second unified TCI state of the plurality of unified TCI states, and a third logical value of the common beam index configuration indicates an association to both a first and a second unified TCI state of the plurality of unified TCI states.
